(19) United States
(12) Patent Application Publication
(10) Pub. No.: US 2008/0127750 A1
(43) Pub. Date: Jun. 5, 2008

(54) Reducing strain level in torque sensing system

(75) Inventors: Palani Thanigachalam, Bangalore (IN); Raja Narayanasamy, Bangalore (IN); Raghavendra Muniraju, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/633,895

(22) Filed: Dec. 5, 2006

(51) Int. Cl. G01L 3/10

(52) U.S. Cl. 73/862.325

(57) ABSTRACT

An apparatus is provided to reduce strain transferred from a body, such as a shaft, to a strain sensor, such as a SAW device. The strain sensor is capable of measuring a maximum amount of strain. A strain absorber has the strain sensor mounted thereon and is arranged to mount the strain sensor to the body. The strain absorber is arranged to transfer a reduced amount of strain from the body to the strain sensor so that the strain on the strain sensor is no greater that the maximum amount of strain.

### TECHNICAL FIELD

The present application relates to reducing the strain level in a system such as in a torque sensing system.

### BACKGROUND

Torque is measured for a variety of applications. For example, it is known to control a vehicle engine in response to the torque measured on the transmission shaft of the vehicle. In at least some instances, the torque on a shaft or other mechanism is measured by measuring the strain on the surface of the shaft and then converting this measured strain to torque. Frequently, strain on a shaft is measured by a surface acoustic wave (SAW) device that is mounted on the surface of the shaft. The maximum measurable strain that can be measured by a typical SAW device is 500 microstrain. However, in many cases, the strain on a shaft is much higher than 500 microstrain. For example, the strain on a shaft can be as high as 2500 microstrain. The typical SAW device is unsuitable for measuring strain in these higher strain applications.

The present invention is directed to an arrangement that solves this or one or more other problems.

### SUMMARY OF THE INVENTION

In accordance with one aspect of the present invention, an apparatus for reducing strain transferred from a body to a strain sensor comprises a strain sensor and a strain absorber. The strain sensor is capable of measuring a maximum amount of strain. The strain absorber has the strain sensor mounted thereon and is arranged to mount the strain sensor to the body. The strain absorber is arranged to transfer a reduced amount of strain from the body to the strain sensor so that the strain on the strain sensor is no greater that the maximum amount of strain.

In accordance with another aspect of the present invention, an apparatus for reducing strain between a shaft and a SAW device comprises a SAW device, a shaft, and a strain absorber. The SAW device is capable of measuring a maximum amount of strain. The shaft is capable of exhibiting strain in excess of the maximum amount. The strain absorber is mounted to the shaft and has the SAW device mounted thereon. The strain absorber is arranged to transfer a reduced amount of strain from the shaft to the SAW device so that the strain on the SAW device is no greater that the maximum amount of strain.

In accordance with yet another aspect of the present invention, a torque measuring system comprises a SAW device, a strain absorber, and a strain-to-torque converter. The SAW device is capable of measuring a maximum amount of strain, and the SAW device provides a strain measuring signal. The strain absorber is arranged to mount the SAW device to a body whose strain is to be measured, the strain absorber has the SAW device mounted thereon, and the strain absorber is arranged to transfer a reduced amount of strain to the SAW device so that the strain on the SAW device is no greater that the maximum amount of strain. The strain-to-torque converter is arranged to convert the strain measuring signal to a torque measuring signal.

### BRIEF DESCRIPTION OF THE DRAWINGS

These and other features and advantages will become more apparent from the detailed description when taken in conjunction with the drawings in which:

FIG. 1 is a front view of an arrangement including a shaft having a strain sensor mounted thereto by a strain absorber according to one embodiment of the present invention;

FIG. 2 is a top view of the embodiment shown in FIG. 1;

FIG. 3 is a front view of an arrangement including a shaft having a strain sensor mounted thereto by a strain absorber according to another embodiment of the present invention;

FIG. 4 is a top view of the embodiment shown in FIG. 3;

FIG. 5 is a front view of an arrangement including a shaft having a strain sensor mounted thereto by a strain absorber according to yet embodiment of the present invention;

FIG. 6 is a side view of the embodiment shown in FIG. 5;

FIG. 7 a top view of the embodiment shown in FIG. 5;

FIG. 8 is a front view of an arrangement including a shaft having a strain sensor mounted thereto by a strain absorber according to still embodiment of the present invention;

FIG. 9 is a top view of the embodiment shown in FIG. 8;

FIG. 10 is a side view of an arrangement including a shaft having a strain sensor mounted thereto by a strain absorber according to a further embodiment of the present invention;

FIG. 11 a top view of the embodiment shown in FIG. 10;

FIG. 12 is a front view of an arrangement including a shaft having a strain sensor mounted thereto by a strain absorber according to a yet further embodiment of the present invention;

FIG. 13 a top view of the embodiment shown in FIG. 12;

FIG. 14 is a front view of an arrangement including a shaft having a strain sensor mounted thereto by a strain absorber according to a still further embodiment of the present invention;

FIG. 15 a top view of the embodiment shown in FIG. 14;

FIG. 16 is a front view of an arrangement including a shaft having a strain sensor mounted thereto by a strain absorber according to another embodiment of the present invention;

FIG. 17 a top view of the embodiment shown in FIG. 16;

FIG. 18 illustrates a shaft having sensors mounted to a shaft and diametrically opposite to one another; and,

FIG. 19 illustrates a first embodiment of a torque sensing system; and,

FIG. 20 illustrates a second embodiment of a torque sensing system.

### DETAILED DESCRIPTION

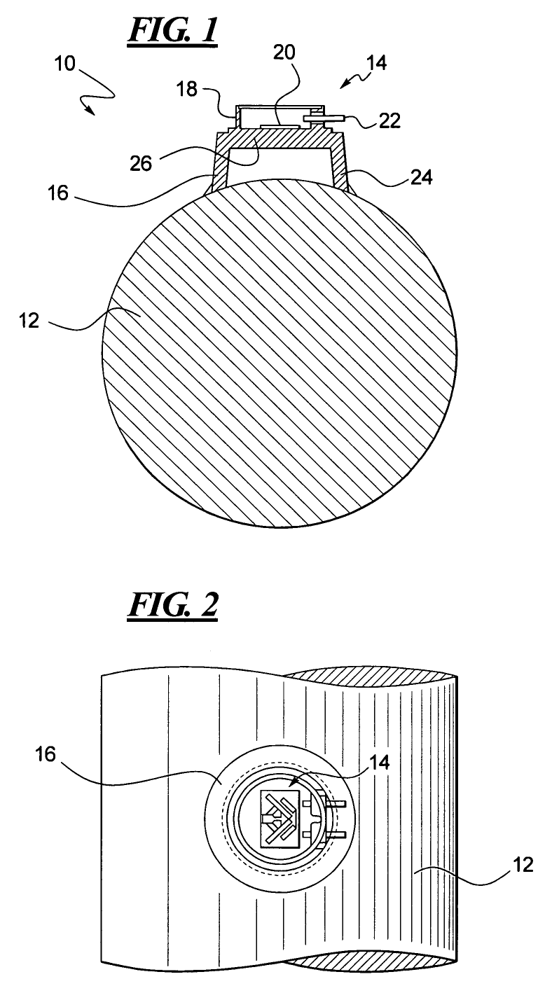

As shown in FIGS. 1 and 2, a strain sensing system 10 includes a shaft 12, a strain sensor 14, and a strain absorber 16 that mounts the strain sensor 14 to the shaft 12. The shaft 12 may be any mechanism that exhibits strain measurable by the strain sensor 14.

The strain sensor 14 includes a housing 18, a SAW device 20, and an terminal 22. However, the strain sensor 14 may include other components. For example, the strain sensor 14 may include components that communicate the measurement of the SAW device 20 from the rotating platform formed by the shaft 12, the strain sensor 14, and the strain absorber 16 to a stationary platform that may include, for example, a controller or other signal processing circuitry that receives and suitably processes the signal from the strain sensor 14. These other components may include, for example, an RF transmitter that transits an RF signal based on the strain measured by the SAW device 20 by way of an antenna connected to the terminal 22. The SAW device 20 and these other components may be integrated in the same IC or as separate ICs or may be arranged as separate circuits as desired. As further desired, the housing 18 and the strain absorber 16 may be integrally formed.

The strain absorber 16 is a circular hollow structure having a cylindrical side wall 24 that forms a cavity therein and that supports an integrally formed circular cover 26 at one end thereof. The strain sensor 14 is attached to the upper surface of the circular cover 26 by a bonding agent or other suitable attachment apparatus. The opposing end of the cylindrical side wall 24 conforms to the shaft 12 and is attached to the shaft 12 by welds, a bonding agent, or other suitable attachment apparatus.

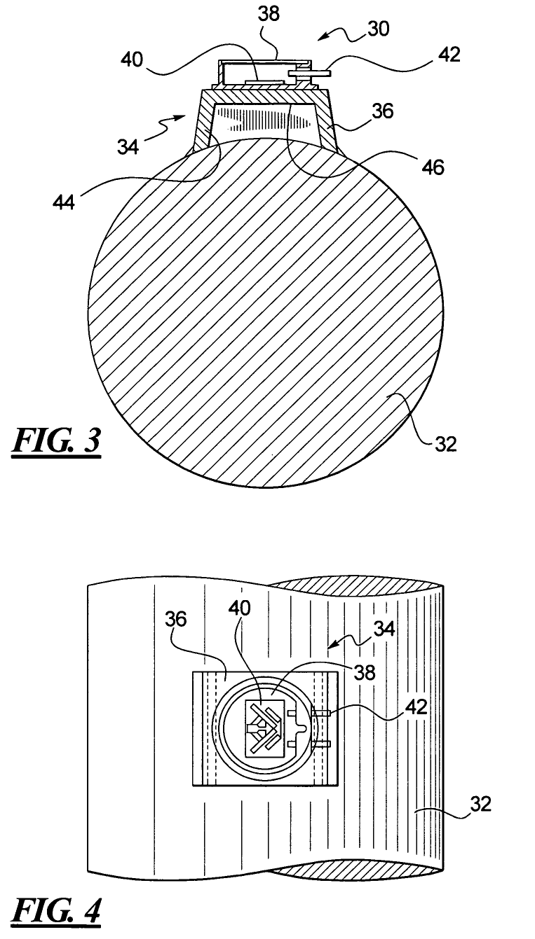

As shown in FIGS. 3 and 4, a strain sensing system 30 includes a shaft 32, a strain sensor 34, and a strain absorber 36 that mounts the strain sensor 34 to the shaft 32. The shaft 32 may be any mechanism that exhibits strain measurable by the strain sensor 34.

The strain sensor 34 includes a housing 38, a SAW device 40, and an terminal 42. The strain sensor 34 may include other components. For example, the strain sensor 34 may include components that communicate the measurement of the SAW device 40 from the rotating platform formed by the shaft 32, the strain sensor 34, and the strain absorber 36 to a stationary platform that may include, for example, a controller or other signal processing circuitry that receives and suitably processes the signal from the strain sensor 34. These other components may include, for example, an RF transmitter that transits an RF signal based on the strain measured by the SAW device 40 by way of an antenna connected to the terminal 42. The SAW device 40 and these other components may be integrated in the same IC or as separate ICs or may be arranged as separate circuits as desired. As further desired, the housing 38 and the strain absorber 36 may be integrally formed.

The strain absorber 36 is a quadrilateral hollow structure having a side wall 44 of quadrilateral cross-section that forms a cavity therein and that supports an integrally formed quadrilateral cover 46 at one end thereof. The strain sensor 34 is attached to the upper surface of the quadrilateral cover 46 by a bonding agent or other suitable attachment apparatus. The opposing end of the side wall 44 conforms to the shaft 32 and is attached to the shaft 32 by welds, a bonding agent, or other suitable attachment apparatus.

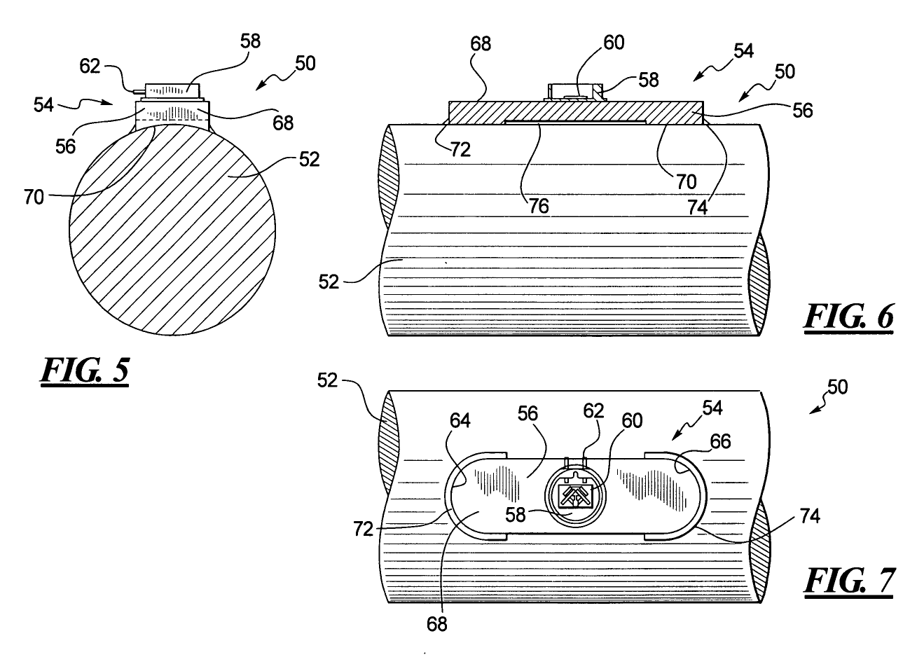

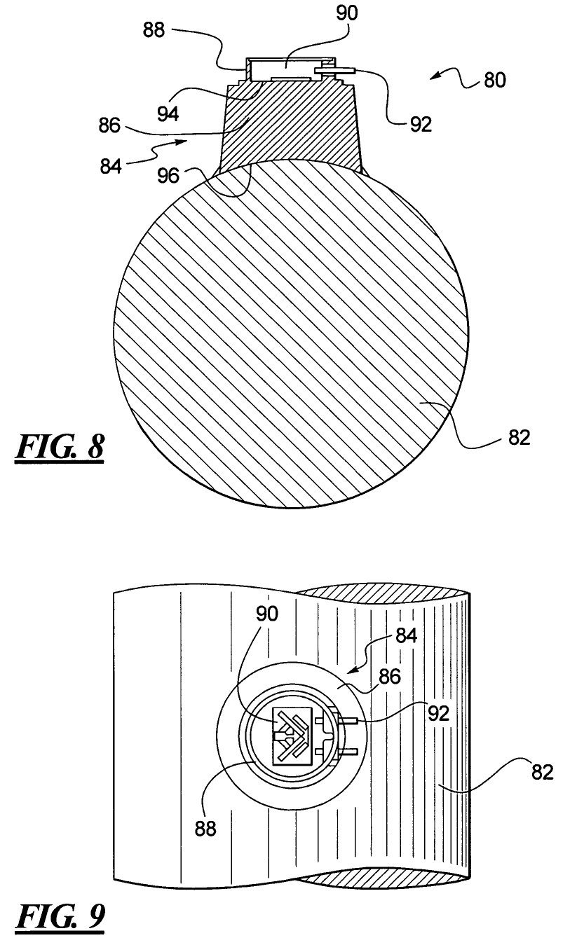

As shown in FIGS. 5, 6, and 7, a strain sensing system 50 includes a shaft 52, a strain sensor 54, and a strain absorber 56 that mounts the strain sensor 54 to the shaft 52. The shaft 52 may be any mechanism that exhibits strain measurable by the strain sensor 34.

The strain sensor 54 includes a housing 58, a SAW device 60, and an terminal 62. The strain sensor 54 may include other components. For example, the strain sensor 54 may include components that communicate the measurement of the SAW device 60 from the rotating platform formed by the shaft 52, the strain sensor 54, and the strain absorber 56 to a stationary platform that may include, for example, a controller or other signal processing circuitry that receives and suitably processes the signal from the strain sensor 54. These other components may include, for example, an RF transmitter that transits an RF signal based on the strain measured by the SAW device 60 by way an antenna connected to of the terminal 62. The SAW device 60 and these other components may be integrated in the same IC or as separate ICs or may be arranged as separate circuits as desired. As further desired, the housing 58 and the strain absorber 56 may be integrally formed.

The strain absorber 56 is an elongated solid structure having rounded ends 64 and 66, a top surface 68, and a bottom surface 70 that conforms to the shaft 52. The strain sensor 54 is attached to the top surface 68 of the strain absorber 56 by a bonding agent or other suitable attachment apparatus. The bottom surface 70 of the strain absorber 56 is attached to the shaft 52 such as by welds 72 and 74 at the ends 64 and 66, or by a bonding agent or other suitable attachment apparatus. As shown in FIG. 6, a recess 76 is formed in the bottom surface 70 of the strain absorber 56.

As shown in FIGS. 8 and 9, a strain sensing system 80 includes a shaft 82, a strain sensor 84, and a strain absorber 86 that mounts the strain sensor 84 to the shaft 82. The shaft 82 may be any mechanism that exhibits strain measurable by the strain sensor 84.

The strain sensor 84 includes a housing 88, a SAW device 90, and an terminal 92. The strain sensor 84 may include other components. For example, the strain sensor 84 may include components that communicate the measurement of the SAW device 90 from the rotating platform formed by the shaft 82, the strain sensor 84, and the strain absorber 86 to a stationary platform that may include, for example, a controller or other signal processing circuitry that receives and suitably processes the signal from the strain sensor 84. These other components may include, for example, an RF transmitter that transits an RF signal based on the strain measured by the SAW device 90 by way of an antenna connected to the terminal 92. The SAW device 90 and these other components may be integrated in the same IC or as separate ICs or may be arranged as separate circuits as desired. As further desired, the housing 88 and the strain absorber 86 may be integrally formed.

The strain absorber 86 is a solid cylindrical button having a top surface 94 and a bottom surface 96. The bottom surface 96 conforms to the shaft 82. The strain sensor 84 is attached to the top surface 94 of the strain absorber 86 by a bonding agent or other suitable attachment apparatus. The bottom surface 96 of the strain absorber 86 is attached to the shaft 82 such as by welds, by a bonding agent, or by other suitable attachment apparatus.

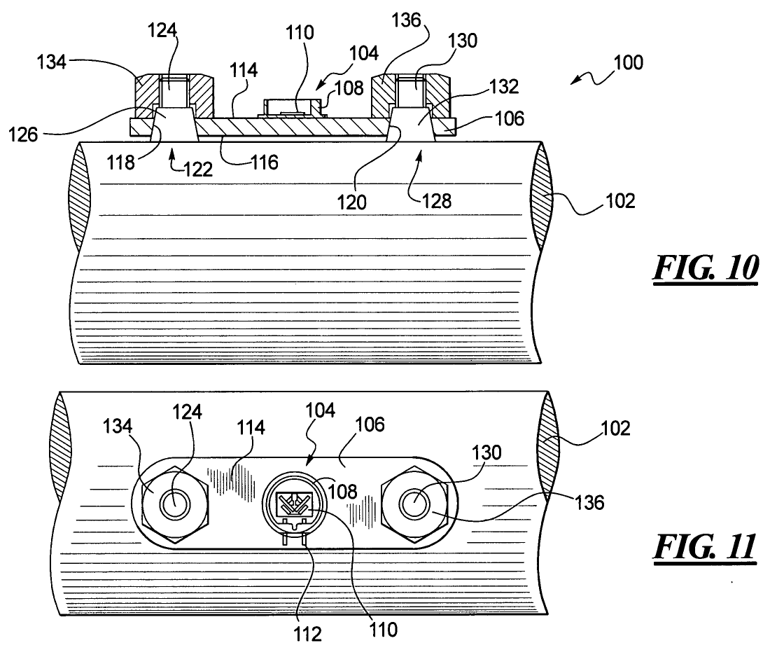

As shown in FIGS. 10 and 11, a strain sensing system 100 includes a shaft 102, a strain sensor 104, and a strain absorber 106 that mounts the strain sensor 104 to the shaft 102. The shaft 102 may be any mechanism that exhibits strain measurable by the strain sensor 104.

The strain sensor 104 includes a housing 108, a SAW device 110, and an terminal 112. The strain sensor 104 may include other components. For example, the strain sensor 104 may include components that communicate the measurement of the SAW device 110 from the rotating platform formed by the shaft 102, the strain sensor 104, and the strain absorber 106 to a stationary platform that may include, for example, a controller or other signal processing circuitry that receives and suitably processes the signal from the strain sensor 104. These other components may include, for example, an RF transmitter that transits an RF signal based on the strain measured by the SAW device 110 by way of an antenna connected to the terminal 112. The SAW device 110 and these other components may be integrated in the same IC or as separate ICs or may be arranged as separate circuits as desired. As further desired, the housing 108 and the strain absorber 106 may be integrally formed.

The strain absorber 106 is a solid member having a top surface 114 and a bottom surface 116 that stands off from and conforms to the shaft 102. The strain sensor 104 is attached to the top surface 114 of the strain absorber 106 by a bonding agent or other suitable attachment apparatus.

The strain absorber 104 has a first hole 118 at one end and a second hole 120 at the other end. The first hole 118 receives a stud 122 having a threaded portion 124 and a flared portion 126. The second hole 120 receives a stud 128 having a threaded portion 130 and a flared portion 132. A first nut 134 is threaded onto the threaded portion 124 of the stud 122 and a second nut 136 is threaded onto the threaded portion 130 of the stud 128 to fasten the strain absorber 104 to the shaft 102. The flared portions 126 and 132 are flared by a selected amount to stand off the strain absorber 104 from the shaft 102 by a desired amount. The studs 122 and 128 conduct strain from the shaft 102 through the strain absorber 106 to the strain sensor 104.

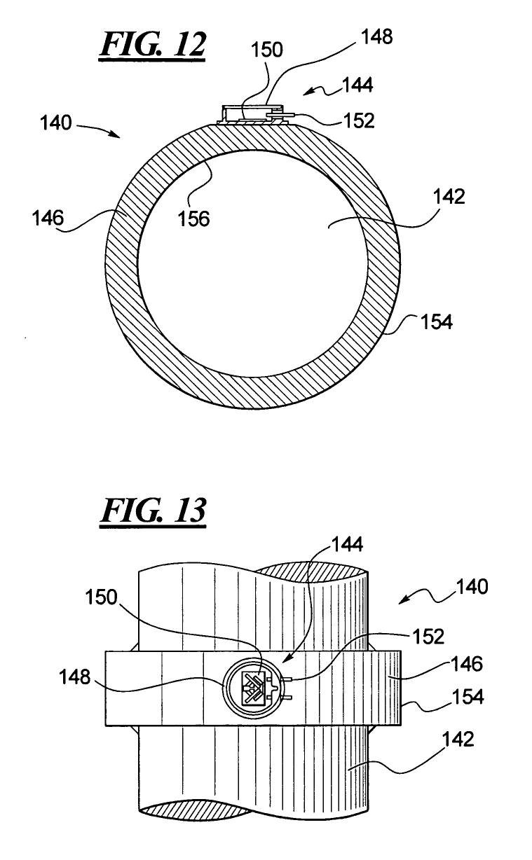

As shown in FIGS. 12 and 13, a strain sensing system 140 includes a shaft 142, a strain sensor 144, and a strain absorber 146 that mounts the strain sensor 144 to the shaft 142. The shaft 142 may be any mechanism that exhibits strain measurable by the strain sensor 144.

The strain sensor 144 includes a housing 148, a SAW device 150, and an terminal 152. The strain sensor 144 may include other components. For example, the strain sensor 144 may include components that communicate the measurement of the SAW device 150 from the rotating platform formed by the shaft 142, the strain sensor 144, and the strain absorber 146 to a stationary platform that may include, for example, a controller or other signal processing circuitry that receives and suitably processes the signal from the strain sensor 144. These other components may include, for example, an RF transmitter that transits an RF signal based on the strain measured by the SAW device 150 by way of an antenna connected to the terminal 152. The SAW device 150 and these other components may be integrated in the same IC or as separate ICs or may be arranged as separate circuits as desired. As further desired, the housing 148 and the strain absorber 146 may be integrally formed.

The strain absorber 146 is in the form of either a solid or hollow ring that encircles and conforms to the shaft 142. The strain sensor 144 is attached to an outer surface 154 of the strain absorber 146 by a bonding agent or other suitable attachment apparatus. For example, the strain sensor 144 may rest on a flattened area of the outer surface 154 of the strain absorber 146. An inner surface 156 of the strain absorber 146 is attached to the shaft 142 such as by welds, by a bonding agent, or by other suitable attachment apparatus.

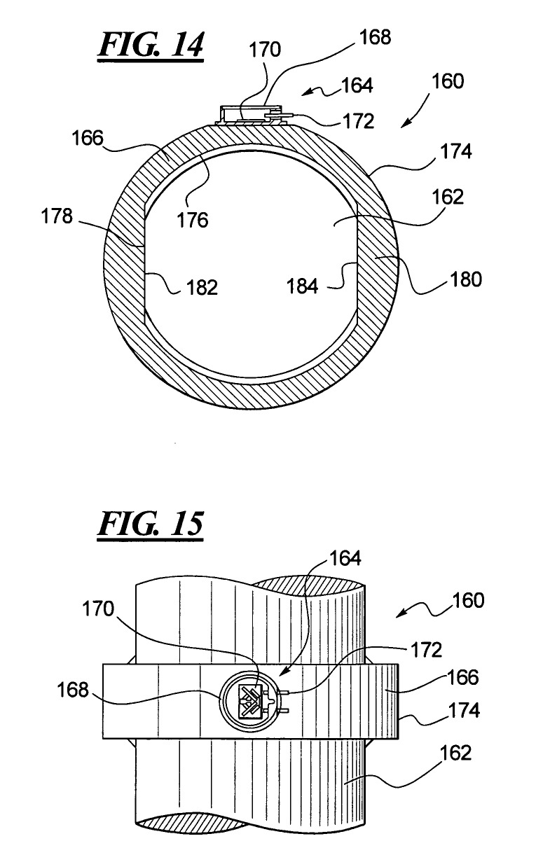

As shown in FIGS. 14 and 15, a strain sensing system 160 includes a shaft 162, a strain sensor 164, and a strain absorber 166 that mounts the strain sensor 164 to the shaft 162. The shaft 162 may be any mechanism that exhibits strain measurable by the strain sensor 164.

The strain sensor 164 includes a housing 168, a SAW device 170, and an terminal 172. The strain sensor 164 may include other components. For example, the strain sensor 164 may include components that communicate the measurement of the SAW device 170 from the rotating platform formed by the shaft 162, the strain sensor 164, and the strain absorber 166 to a stationary platform that may include, for example, a controller or other signal processing circuitry that receives and suitably processes the signal from the strain sensor 164. These other components may include, for example, an RF transmitter that transits an RF signal based on the strain measured by the SAW device 170 by way an antenna connected to of the terminal 172. The SAW device 170 and these other components may be integrated in the same IC or as separate ICs or may be arranged as separate circuits as desired. As further desired, the housing 168 and the strain absorber 166 may be integrally formed.

The strain absorber 166 is in the form of either a solid or hollow ring that encircles and conforms to the shaft 162. The strain sensor 164 is attached to an outer surface 174 of the strain absorber 166 by a bonding agent or other suitable attachment apparatus. For example, the strain sensor 164 may rest on a flattened area of the outer surface 174 of the strain absorber 166. An inner surface 176 of the strain absorber 166 is attached to the shaft 162 such as by welds, by a bonding agent, or by other suitable attachment apparatus.

In addition, the inner surface 176 of the strain absorber 166 may have opposing flats 178 and 180 that cooperated with opposing flats 182 and 184 of the shaft 162. The flats 178, 180, 182, and 184 provide for polarized mating between the strain absorber 166 and the shaft 162.

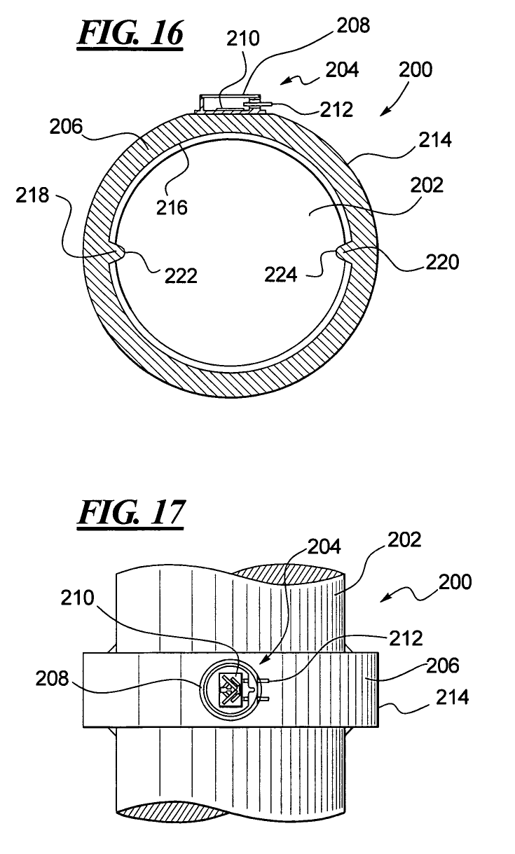

As shown in FIGS. 16 and 17, a strain sensing system 200 includes a shaft 202, a strain sensor 204, and a strain absorber 206 that mounts the strain sensor 204 to the shaft 202. The shaft 202 may be any mechanism that exhibits strain measurable by the strain sensor 204.

The strain sensor 204 includes a housing 208, a SAW device 210, and an terminal 212. The strain sensor 204 may include other components. For example, the strain sensor 204 may include components that communicate the measurement of the SAW device 210 from the rotating platform formed by the shaft 202, the strain sensor 204, and the strain absorber 206 to a stationary platform that may include, for example, a controller or other signal processing circuitry that receives and suitably processes the signal from the strain sensor 204. These other components may include, for example, an RF transmitter that transits an RF signal based on the strain measured by the SAW device 210 by way of an antenna connected to the terminal 212. The SAW device 210 and these other components may be integrated in the same IC or as separate ICs or may be arranged as separate circuits as desired. As further desired, the housing 208 and the strain absorber 206 may be integrally formed.

The strain absorber 206 is in the form of either a solid or hollow ring that encircles and conforms to the shaft 202. The strain sensor 204 is attached to an outer surface 214 of the strain absorber 206 by a bonding agent or other suitable attachment apparatus. For example, the strain sensor 204 may rest on a flattened area of the outer surface 214 of the strain absorber 206. An inner surface 216 of the strain absorber 206 is attached to the shaft 202 such as by snap fitting into grooves in the shaft 202, or by other suitable attachment apparatus.

In addition, the inner surface 216 of the strain absorber 206 may have opposing projections 218 and 220 that cooperate with opposing indents 222 and 224 of the shaft 202. The projections 218 and 220 and the indents 222 and 224 provide for polarized mating between the strain absorber 206 and the shaft 202.

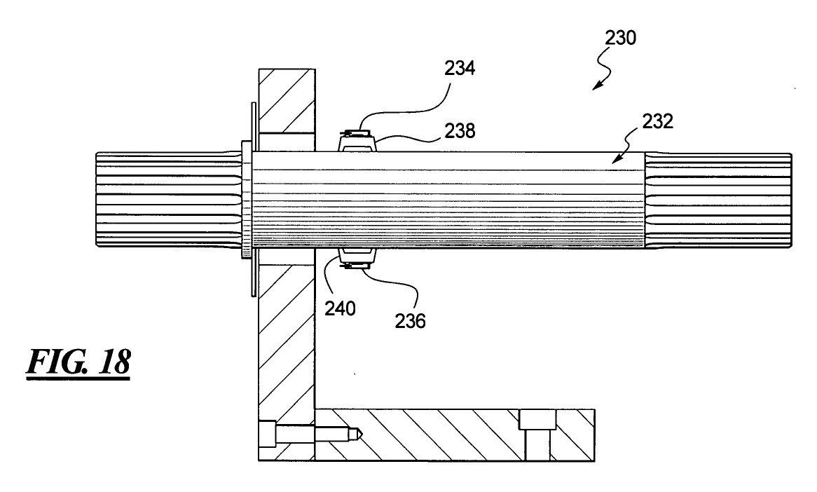

As shown in FIG. 18, a strain sensing system 230 includes a shaft 232, first and second strain sensors 234 and 236, and first and second strain absorbers 238 and 240. The first strain absorber 238 mounts the first strain sensor 234 to the shaft 232, and the second strain absorber 240 mounts the second strain sensor 236 to the shaft 232 so that the second strain sensor 236 is substantially diametrically opposed to the first strain sensor 234. The first and second strain absorbers 238 and 240 may have any of the configurations shown above.

The strain that is sensed by a strain sensor can be typically on the order of 2500 microstrain. By properly dimensioning the strain absorbers with respect to the shafts on which the strain absorbers mount the strain sensors, the strain absorbers described above are able to reduce that strain on the strain sensors to at or below the 500 microstrain that is typically the maximum strain that a strain sensor such as SAW device can measure.

The strain absorber in each of the embodiments described above may be formed from any suitable material such as metal, plastic, an elastomeric material, etc. The material of the strain absorber, for example, may be the same as the material that is used for the shaft that supports the strain absorber. The dimensions of the strain absorber are dependent on the strain produce in the shaft. The strain produced in turn depends on the shaft diameter, the applied torque, and the shaft material. Also, the dimensions of the strain absorber may be optimized to provide the desired amount of strain reduction between the strain on the surface of its corresponding shaft and the strain on the strain sensor supported by the strain absorber. Further, the material of the strain absorber may be selected to affect the amount of strain reduction that is desired.

FIG. 19 illustrates a torque sensing system 250 having a strain sensor 252 and a strain-to-torque converter 254. The strain sensor 252 may be any type of strain sensor, such as any of the strain sensors described above in connection with FIGS. 1-18. The strain-to-torque converter 254 may be any type of processor, such as an ASIC, a field programmable gate array, a microcomputer, etc., capable of converting the strain measurement provided by the strain sensor 252 to a torque output. For example, since the strain vs. torque relationship is known, the strain-to-torque converter 254 may implement an equation, a look up table, etc. in order to make the strain to torque conversion.

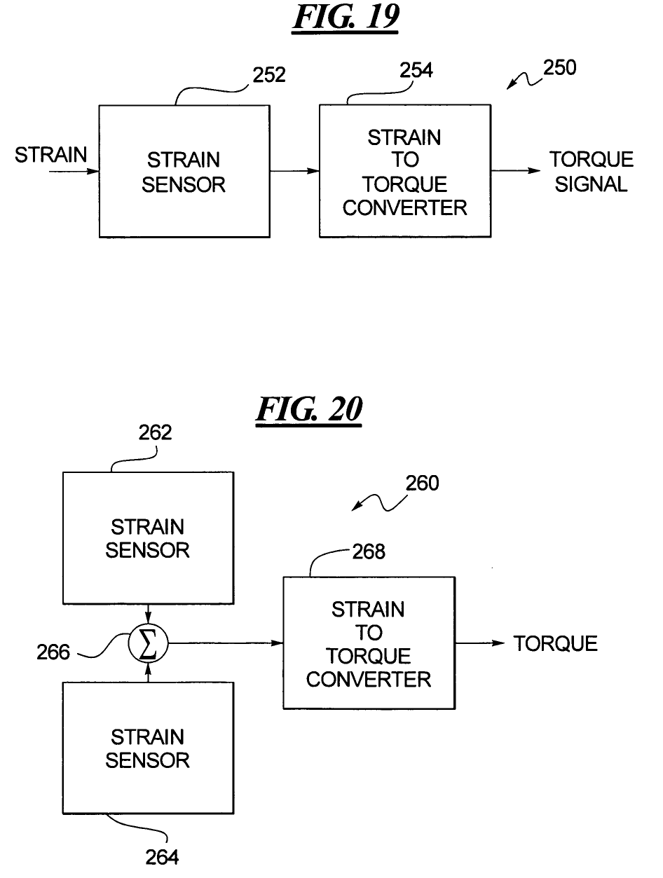

FIG. 20 illustrates a torque sensing system 260 having a first strain sensor 262, a second strain sensor 264, a comparator 266, and a strain-to-torque converter 268. The first strain sensor 262 may be any type of strain sensor, such as any of the strain sensors described above in connection with FIGS. 1-18. Similarly, the second strain sensor 264 may be any type of strain sensor, such as any of the strain sensors described above in connection with FIGS. 1-18. The comparator 266, for example, may be a summer having an input to receive the output of the first strain sensor 262 and an input to receive the output of the second strain sensor 264. The output of the summer 266 is the average between the outputs of the first and second strain sensors 262 and 264, which eliminates bending load errors. The strain-to-torque converter 268 may be any type of processor, such as an ASIC, a field programmable gate array, a microcomputer, etc., capable of converting the strain measurement provided by the summer 266 to a torque output.

Each of the strain sensors 234 and 236 could consist of two resonators mounted 45° apart about the shaft axis. The purpose of using two resonators (F1, F2) in each of the strain sensors 234 and 236 would be to eliminate common mode errors such as thermal related errors, centrifugal force errors acting on the sensor during rotation, etc. The common mode errors are eliminated by taking the difference of the two resonator outputs (F1−F2).

Certain modifications of the present invention have been discussed above. Other modifications of the present invention will occur to those practicing in the art of the present invention. For example, SAW devices have been disclosed above as the elements of the strain sensors that measure strain on a shaft. However, devices other than SAW devices can be used in connection with the present invention to measure strain on a shaft.

Also, strain sensors are described above as including RF devices that use antennas to transmit their strain or torque measurements to a stationary receiver. However, the strain or torque measurements may be communicated to a stationary device by use of mechanisms other than antennas and RF transmissions.

In addition, the strain sensors as described above measure strain on shafts. Instead, the strain sensors can be used to measure strain on mechanisms other than shafts.

Moreover, the strain measurement may be converted to a torque measurement by either the rotating platform or by the stationary platform. Thus, the strain-to-torque converter 254 may be located with the strain sensor 252 on the rotating platform or instead may be located on the stationary platform while the strain sensor 252 is located on the rotating platform. Similarly, the summer 266 and the strain-to-torque converter 268 may be located with the first and second strain sensors 262 and 264 on the rotating platform or instead may be located on the stationary platform while the first and second strain sensors 262 and 264 are located on the rotating platform. As a further alternative, the summer 266 may be located with the first and second strain sensors 262 and 264 on the rotating platform and the strain-to-torque converter 268 may be located on the stationary platform. Accordingly, either the strain measurement or the torque measurement or an intermediate signal may be communicated from the rotating platform to the stationary platform.

Furthermore, the drawings show strain sensors being mounted to the exterior surfaces of the strain absorbers. In certain embodiments, the strain sensors could instead be mounted to interior surfaces of the strain absorbers.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. An apparatus for reducing strain transferred from a body to a strain sensor comprising:
a strain sensor capable of measuring a maximum amount of strain; and,
a strain absorber having the strain sensor mounted thereon and arranged to mount the strain sensor to the body, the strain absorber being arranged to transfer a reduced amount of strain from the body to the strain sensor so that the strain on the strain sensor is no greater that the maximum amount of strain.

2. The apparatus of claim 1 wherein the strain absorber is arranged to reduce the amount of strain from the body to the strain sensor on the order of at least 3 to 1.

3. The apparatus of claim 1 wherein the strain absorber is arranged to reduce the amount of strain from the body to the strain sensor on the order of 5 to 1.

4. The apparatus of claim 1 wherein the strain absorber comprises:
a cylindrical side wall forming a hollow cavity therein and having first and second ends, the first end being arranged to engage the body; and,
a circular disk at the second end, the circular disk supporting the strain sensor.

5. The apparatus of claim 1 wherein the strain absorber comprises:
a quadrilateral side wall forming a hollow cavity therein and having first and second ends, the first end being arranged to engage the body; and,
a quadrilateral cover at the second end, the quadrilateral cover supporting the strain sensor.

6. The apparatus of claim 1 wherein the strain absorber comprises a solid member.

7. The apparatus of claim 6 wherein the solid member comprises an elongated solid member.

8. The apparatus of claim 7 wherein the solid member comprises a recess.

9. The apparatus of claim 1 wherein the strain absorber comprises a ring.

10. The apparatus of claim 9 wherein the ring comprises polarizing devices with respect to the body.

11. The apparatus of claim 1 wherein the strain sensor comprises a SAW device.

12. An apparatus for reducing strain between a shaft and a SAW device comprising:
a SAW device capable of measuring a maximum amount of strain;
a shaft capable of exhibiting strain in excess of the maximum amount; and,
a strain absorber mounted to the shaft and having the SAW device mounted thereon, the strain absorber being arranged to transfer a reduced amount of strain from the shaft to the SAW device so that the strain on the SAW device is no greater that the maximum amount of strain.

13. The apparatus of claim 12 wherein the strain absorber is arranged to reduce the amount of strain from the shaft to the SAW device on the order of at least 3 to 1.

14. The apparatus of claim 12 wherein the strain absorber is arranged to reduce the amount of strain from the shaft to the SAW device on the order of 5 to 1.

15. The apparatus of claim 12 wherein the strain absorber comprises:
a cylindrical side wall forming a hollow cavity therein and having first and second ends, the first end engaging the shaft; and,
a circular disk at the second end, the circular disk supporting the SAW device.

16. The apparatus of claim 12 wherein the strain absorber comprises:
a quadrilateral side wall forming a hollow cavity therein and having first and second ends, the first end engaging the shaft; and,
a quadrilateral cover at the second end, the quadrilateral cover supporting the SAW device.

17. The apparatus of claim 12 wherein the strain absorber comprises a solid member.

18. The apparatus of claim 17 wherein the solid member comprises an elongated solid member.

19. The apparatus of claim 18 wherein the solid member comprises a recess.

20. The apparatus of claim 12 wherein the strain absorber comprises a ring.

21. The apparatus of claim 20 wherein the ring comprises polarizing devices with respect to the shaft.

22. A torque measuring system comprising:
a SAW device capable of measuring a maximum amount of strain, the SAW device providing a strain measuring signal;
a strain absorber being arranged to mount the SAW device to a body whose strain is to be measured, the strain absorber having the SAW device mounted thereon, the strain absorber being arranged to transfer a reduced amount of strain to the SAW device so that the strain on the SAW device is no greater that the maximum amount of strain; and,
a strain-to-torque converter, wherein the strain-to-torque converter is arranged to convert the strain measuring signal to a torque measuring signal.
